(19) United States
(12) Patent Application Publication
(10) Pub. No.: US 2013/0339186 A1
(43) Pub. Date: Dec. 19, 2013

(54) Identifying Fraudulent Users Based on Relational Information

(71) Applicants: Steven Neal French, Sunnyvale, CA (US); Tilmann Bruckhaus, Cupertino, CA (US)

(72) Inventors: Steven Neal French, Sunnyvale, CA (US); Tilmann Bruckhaus, Cupertino, CA (US)

(73) Assignee: EVENTBRITE, INC., San Francisco, CA (US)

(21) Appl. No.: 13/524,459

(22) Filed: Jun. 15, 2012

(51) Int. Cl. G06F 21/00; G06F 15/16; G06Q 30/06

(52) U.S. Cl. 705/26.35; 726/26

(57) ABSTRACT

In one embodiment, a method includes accessing a first event profile that includes a seed event parameter and a first event parameter, calculating fraud scores for the first event parameter, accessing a second event profile that includes a second event parameter that corresponds to the first event parameter, calculating a fraud score for the second event parameter, and then identifying the second parameters as being associated with fraud. Fraud scores may be calculated based on the attributes of a parameter, the relation of the parameter to the seed parameter, and the fraud scores of any corresponding parameters.

### TECHNICAL FIELD

The present disclosure generally relates to online event management systems and fraud detection systems.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event profiles, register for events, and purchase tickets for events. Online systems, such as online event management systems, can typically be accessed using suitable browser clients (e.g., MOZILLA FIREFOX, GOOGLE CHROME, MICROSOFT INTERNET EXPLORER).

### BRIEF DESCRIPTION OF THE DRAWINGS

FIG. 1 illustrates an example system for implementing an online event management system and an online fraud detection system.

FIG. 2 illustrates an example method for evaluating event profiles for fraud.

FIG. 3 illustrates an example graph showing the relationship between various event parameters.

FIGS. 4A-4C illustrate example graphs showing the relationship between the event parameters of multiple event profiles.

FIG. 5 illustrates an example graph showing the calculation of fraud scores for various event parameters.

FIG. 6 illustrates an example method for detecting fraud using relational information.

FIG. 7 illustrates an example computer system.

FIG. 8 illustrates an example network environment.

### DESCRIPTION OF EXAMPLE EMBODIMENTS

### System Overview

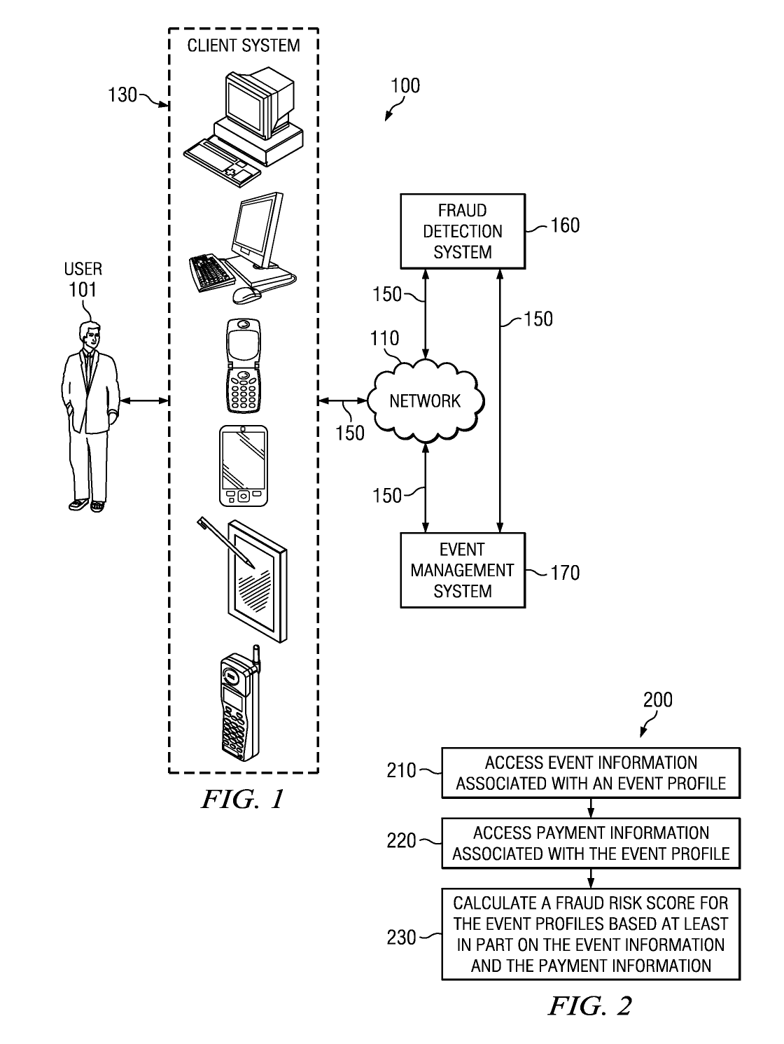

FIG. 1 illustrates an example system 100 for implementing an online event management system and a fraud detection system. System 100 includes a user 101, a client system 130, a fraud detection system 160, and an event management system 170 connected to each other by a network 110. Although FIG. 1 illustrates a particular arrangement of user 101, client system 130, fraud detection system 160, event management system 170, and network 110, this disclosure contemplates any suitable arrangement of user 101, client system 130, fraud detection system 160, event management system 170, and network 110. As an example and not by way of limitation, two or more of client system 130, fraud detection system 160, and event management system 170 may be connected to each other directly, bypassing network 110. As another example and not by way of limitation, two or more of client system 130, fraud detection system 160, and event management system 170 may be physically or logically co-located with each other in whole or in part. As yet another example, one or more fraud detection systems 160 may be physically or logically co-located with one or more event management systems 170 in whole or in part. Moreover, although FIG. 1 illustrates a particular number of users 101, client system 130, fraud detection systems 160, event management systems 170, and networks 110, this disclosure contemplates any suitable number of users 101, client systems 130, fraud detection systems 160, event management systems 170, and networks 110. As an example and not by way of limitation, system 100 may include multiple users 101, client systems 130, fraud detection systems 160, event management systems 170, and networks 110.

In particular embodiments, an event management system 170 may be a network-addressable computing system that can host one or more event organization and management systems. An event management system 170 may generate, store, receive, and transmit event-related data, such as, for example, event profiles, event details, event history details, event registration details, event organizer details, event attendee details, ticket purchase details, and event displays. An event management system 170 may be accessed by the other components of system 100 either directly or via network 110. In particular embodiments, fraud detection system 160 may be a network-addressable computing system that can host one or more pricing engines or modules. Fraud detection system 160 may generate, store, receive, and transmit fraud-risk-related information, such as, for example, event-related data, event organizer information, purchase information, and other data relevant to detecting fraudulent events. Fraud detection system 160 may be accessed by the other components of system 100 either directly or via network 110. Fraud detection system 160 may be an independent system or a subsystem of event management system 170.

In particular embodiments, one or more users 101 may use one or more client systems 130 to access, send data to, and receive data from an event management system 170. A client system 130 may access an event management system 170 directly, via network 110, or via a third-party system. A client system 130 may be any suitable computing device, such as, for example, a personal computer, a laptop, a cellular phone, a smart phone, or a computing tablet. In particular embodiments, one or more users 101 may be an automated system, such as, for example, a computer program, an internet bot, another type of automated system, or two or more such systems.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections 150 may connect client system 130, fraud detection system 160, and event management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another connection 150, or a combination of two or more such connections 150. Connections 150 need not necessarily be the same throughout system 100. One or more first connections 150 may differ in one or more respects from one or more second connections 150.

### Event Management Systems

In particular embodiments, an event management system 170 may allow users to create, organize and manage events. An event may be, for example, a party, a concert, a conference, a sporting event, a fundraiser, a networking event, or a live performance. Events may occur online (such as, for example, a web-based seminar) and offline (such as, for example, a live seminar in a lecture hall). An online event management system may allow an event organizer to organize and manage various aspects of an event, such as, for example, creating event profiles, managing attendee registrations and selling tickets, managing funds from ticket sales, promoting the event, and managing attendee check-in at the event. An online event management system may also allow event attendees to view and manage various aspects of registering for an event, such as, for example, viewing event profiles, viewing event history information, registering for events, and purchasing tickets for events. As an example and not by way of limitation, a first user may use event management system 170 to create and organize an event. The first user may create an event profile for the event and input event information or event parameters associated with the event. As used herein, the terms “event information” and “event parameter” may be used interchangeably to refer to data in an event profile describing one or more aspects of or related to an event. The event profile may be viewable in one or more webpages or other content served by event management system 170. One or more second users may then use event management system 170 to register for the event. The second users may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event management system 170 may have an event profile associated with each event managed by the system. An event profile may be accessed and displayed by any suitable client system 130. An event profile may include event information describing the event title, the event date/time, the event category or type, the event details, the description of the event, the event cost or ticket price for the event, the event organizer, the event promoter, the geographic location of the event, the venue for the event, a venue capacity, the performer for the event, the number of tickets available for the event, the type/class of tickets available for the event, the ticket identifiers, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, and the like), privacy settings for the event profile, or other suitable event information. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, IP address, device identifier, purchase information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR code, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, the event profile may include purchase information for the event. A purchase information may include, for example, a user 101's name, phone number, mailing address, email address, billing address, payment information, ticket order information, credit card information, bank account number, PAYPAL username, cash payment information, money transfer information, address verification system score for the payment, validity information for the payment, or other suitable purchase information. Although this disclosure describes particular types of purchase information, this disclosure contemplates any suitable types of purchase information.

In particular embodiments, each user 101 of event management system 170 may have an event history information associated with the user 101. Event history information may include event information and purchase information associated with one or more events a user 101 has attended or has registered to attend, as well as purchase history information associated with each event. Event history information may also include event information associated with one or more event profiles a user 101 has created, organized, and managed. Although this disclosure describes particular event history information, this disclosure contemplates any suitable event history information.

In particular embodiments, the event management system 170 may use a unique client identifier (ID) to identify a user 101. As an example and not by way of limitation, the event management system 170 may assign a unique device ID to each client system 130. The event management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event management system 170 may assign a unique user ID to each user 101, which the user may provide to the event management system 170 via a client system 130. The event management system 170 may assign each user 101 with a username and password that the user 101 can input into client system 130, which then transmits the username and password to the event management system 170. In particular embodiments, the event management system 170 can use the unique client identifier (such as, for example, a device ID or user ID) to determine that the user 101 is accessing the system. As yet another example and not by way of limitation, the event management system 170 may assign a unique client identifier to each attendee of an event. Although this disclosure describes particular types of unique client identifiers, this disclosure contemplates any suitable types of unique client identifiers. Moreover, although this disclosure describes using client identifiers in a particular manner, this disclosure contemplates using client identifiers in any suitable manner.

In particular embodiments, the event management system 170 may maintain an event management account for a user 101. The event management account may contain a variety of information about the user 101. As an example and not by way of limitation, an event management account may contain personal information (such as, for example, name, sex, location, interests), social network information (such as, for example, friend connections, personal information about user 101's friends), financial information (such as, for example, income, credit history), event history information (such as, for example, the type, data, cost, venue, performers, geographic location of the events a user 101 has organized, registered for, or attended), or other suitable information related to the user 101. Although this disclosure describes event management accounts containing particular types of information about a user 101, this disclosure contemplates event management accounts containing any suitable information about a user 101.

In particular embodiments, an event management system 170 may use a “shopping cart” model to facilitate event registration. As an example and not by way of limitation, event management system 170 may present a user 101 with a plurality of event profiles. The user 101 may select one or more of the events to register for. When the user 101 selects an event profile on event management system 170, the event management system 170 may metaphorically add that item (e.g., registration for the event) to a shopping cart. If appropriate, the user 101 may also select a ticket type or a number of tickets for the event. When the user 101 is done selecting event profiles, then all the items in the shopping cart may be “checked out” (i.e., ordered) when the user 101 provides purchase information (and possibly shipment information). In some embodiments, when a user 101 selects an event profile, then that event profile may be “checked out” by automatically prompting the user for purchase information, such as, for example, the user's name and purchase information. The user 101 then may be presented with a registration webpage that prompts the user for the user-specific registration information to complete the registration. That webpage may be pre-filled with information that was provided by the user 101 when registering for another event or when establishing an event management account on the event management system 170. The information may then be validated by the event management system 170, and the registration may be completed. At this point, the user 101 may be presented with a registration confirmation webpage or a receipt that displays the details of the event and registration details. Event management system 170 may also charge or withdraw funds from a financial account associated with user 101 based on the purchase information provided by the user 101. The “shopping cart” model may be facilitated by a client system 130 operating offline from event management system 170. Although this disclosure describes particular means for registering for events and purchasing tickets, this disclosure contemplates any suitable means for registering for events and purchasing tickets.

In particular embodiments, an event management system 170 may facilitate paying out funds to an event organizer The event management system 170 may collect funds from ticket buyers, hold these funds, and transfer some or all of the funds to the event organizer In particular embodiments, one or more users 101 may buy one or more tickets on event management system 170, and the system may collect some or all of the funds associated with these ticket sales. As an example and not by way of limitation, nine users 101 may purchase tickets to a concert using event management system 170. If the tickets cost $100 each, then event management system 170 would have collected $900 from the users 101. In particular embodiments, event management system 170 may then pay out funds from ticket sales to an event organizer As an example and not by way of limitation, event management system 170 may transfer or deposit the funds into a financial account associated with the event organizer. Event management system 170 may pay out some or all of the funds. For example, if each $100 ticket includes an $8 service charge, event management system 170 may only pay out $92 per ticket to the event organizer In particular embodiments, event management system 170 may pay out funds to the event organizer at particular times. As an example and not by way of limitation, event management system 170 may pay out funds to an event organizer after each ticket sale. As another example and not by way of limitation, event management system 170 may pay out funds in response to a request from the event organizer. The event organizer may request to withdraw all funds from his account. Alternatively, the event organize may request to withdraw less than all the funds. For example, if event management system 170 has collected $900 from selling tickets, the event organizer may request that the system pay out only $700. In particular embodiments, event management system 170 may hold funds for a particular time period. Event management system 170 may hold these funds for a time sufficient to allow payments to clear or be verified. Payments may be verified or cleared by a bank, a credit card issuer, a credit card processor, or a fraud detection system 160. If the funds used to purchase a ticket have not yet cleared, event management system 170 may hold the funds and not allow these funds to be paid out. Although this disclosure describes a particular means for paying out funds to an event organizer, this disclosure contemplates any suitable means for paying out funds to an event organizer

### Fraud Detection Systems

Some users of an online event management system may attempt to improperly use the system, such as by violating the terms of services of the system or by using the system to commit illegal acts. One type of improper use is creating event profiles that contain spam or other improper advertisements. For example, a user may create an online event profile for a fake event and then use the event profile to display an advertisement for a product (e.g., erectile dysfunction drugs, nutraceuticals, pornography). Another type of improper use is creating event profiles in order to make fraudulent financial transactions. For example, a user may create an online event profile for a fake event. The user, and possibly one or more accomplices, may then use stolen credit cards to purchase tickets to the fake event. The user may then request that the system pay out money to the user for the fraudulently purchased tickets. If the online event management system pays out the money before the purchases can be verified (such as, for example, by a credit card processor, a credit card issuer, or a fraud detection system) the system may lose money when the fraudulent purchases are identified by the rightful owners of the stolen credit cards. In this case, there may be a chargeback on the purchase, where the online event management system may have to pay the fraudulently charged funds back to the rightful owner. Furthermore, funds already paid out to the fraudster cannot typically be recovered, resulting in an overall loss. Additional losses may result from chargeback fees.

In particular embodiments, a fraud detection system 160 may evaluate one or more event profiles for potential or actual fraud. Fraud detection system 160 may be an independent system or a subsystem of event management system 170. Fraud detection system 160 may access event profiles and associated event information and purchase information on event management system 170 and analyze the event profiles for improper, fraudulent, or illegal use. Although this disclosure describes particular methods for evaluating event profiles for fraud, this disclosure contemplates any suitable methods for evaluating event profiles for fraud. Moreover, although this disclosure describes particular methods for evaluating event profiles for fraud, this disclosure contemplates using the same methods for evaluation the event parameters of an event profile for fraud.

In particular embodiments, an event profile may be evaluated for fraud by calculating a fraud score for the event profile. A fraud score may represent the probability an event profile is fraudulent or is associated with fraud, the percentile rank of the risk of fraud associated with the event profile in relation to other event profiles, or other suitable scoring representations. As an example and not by way of limitation, fraud detection system 160 may analyze a set of event profiles for fraud and calculate a preliminary fraud value associated with the risk of fraud for each event profile. Fraud detection system 160 may then sort the event profiles by preliminary fraud value and calculate a percentile rank associate with each event profile or preliminary fraud value. The percentile ranks may then be used as the fraud scores for the event profiles. As another example and not by way of limitation, fraud detection system 160 may analyze a set of event profiles and determine the mean, standard deviation, or normalized values for particular types of event information and purchase information. Fraud detection system 160 may then calculate the deviation of each event profile from these mean or nominal values, such that an event profile with more or larger deviations may have a higher fraud score than an event profile with fewer or smaller deviations. For example, if the nominal value for a geographic location of an event is equal to “United States,” then event profiles with geographic locations equal to “Nigeria” may have high fraud scores than event profiles with geographic locations equal to “United States.” As another example, if the mean credit card decline rate for ticket purchases is 8% with a standard deviation of ±4%, then an event profile with a credit card decline rate of 40% may have a high fraud score. Although this disclosure describes using particular methods for scoring the risk of fraud associated with an event profile, this disclosure contemplates using any suitable methods for scoring the risk of fraud associated with an event profile.

In particular embodiments, fraud detection system 160 may calculate a fraud score for an event profile based on a variety of factors, such as, for example, event information associated with the event profiles, purchase information associated with the event profile, the amount of funds to be paid out to the event organizer, other suitable event information, or two or more such factors. The following is an example algorithm that fraud detection system 160 could use to calculate a fraud score:

f_{fraud}=f(E₁, . . . , Eₙ, P₁, . . . , Pₘ, R)

where:
f_{fraud} is the fraud score for the event profile,
E₁, . . . , Eₙ are event information 1 through n,
P₁, . . . , Pₘ are purchase information 1 through m
R is the amount at-risk, which is the amount of funds to be paid out to the event organizer

Although this disclosure describes calculating a fraud score using a particular algorithm, this disclosure contemplates calculating a fraud score using any suitable algorithm. Moreover, although this disclosure describes calculating a fraud score using particular variables that represent particular information, this disclosure contemplates calculating a fraud score using any suitable variables representing any suitable information.

In particular embodiments, fraud detection system 160 may evaluate an event profile for fraud at particular times. Fraud detection may be in real-time or post-facto. As an example and not by way of limitation, fraud detection system 160 may evaluate an event profile for fraud when the event profile is created by an event organizer As another example and not by way of limitation, fraud detection system 160 may evaluate an event profile for fraud when the event organizer makes a request to pay out funds. As yet another example and not by way of limitation, fraud detection system 160 may evaluate an event profile for fraud periodically, such as once an hour, once a day, or another suitable period. In particular embodiments, fraud detection system may evaluate a set of event profiles for fraud in a particular order or sequence. Fraud detection system 160 may evaluate one or more event profiles individually, in parallel, in batches, in whole, or by other suitable amounts. Although this disclosure describes evaluating event profiles at particular times, this disclosure contemplates evaluating event profiles at any suitable time.

In particular embodiments, fraud detection system 160 may evaluate an event profile for fraud based on the event information associated with the event profile. Event information may include information describing the event date, type, cost, organizer, promoter, geographic location, venue, performer, attendees, and other suitable event information. Event information may also include information describing the event organizer, such as, for example, the event organizer's name, email, contact information, location, IP address, reputation, financial information, credit score, bank account number, payment history, and other suitable information about the event organizer In particular embodiments, fraud detection system 160 may evaluate an event profile for fraud based on the location of the event. Events in particular locations or countries may be more likely to be fraudulent than events in other locations or countries. The location of an event may be inputted by an event organizer when he creates an event profile on event management system 170. As an example and not by way of limitation, events located in the United States or the European Union may have lower fraud scores than events located in various African nations or former Eastern Bloc countries that are known to be fraud risks. As another example and not by way of limitation, events located in unknown or imaginary locations may have higher fraud scores than events located in known locations. An event profile with a location of “Arvandor,” which is a mythical location, may have a higher fraud score than an event profile with a location of “Golden Gate Park,” which is a real location. In particular embodiments, fraud detection system 160 may evaluate an event profile for fraud based on the location of the event organizer of the event. Event organizers in particular locations or countries may be more likely to create fraudulent event profiles than event organizers in other locations or countries. The location of an event organizer may be determined by querying the event organizer, from the event organizer's financial or personal information, by examining the IP address of the event organizer when he accesses event management system 170, or by other suitable methods. As an example and not by way of limitation, an event profile with an event organizer from Romania may have a higher fraud score than an event profile with an event organizer from the United States, where event organizers in particular foreign countries may be more likely to create fraudulent event profiles. As another example and not by way of limitation, an event profile with an event organizer in Rikers Island Prison Complex may have a higher fraud score than an event profile with an event organizer who is not in prison, where event organizers in prison may be more likely to create fraudulent event profiles. In particular embodiments, fraud detection system 160 may evaluate an event profile for fraud based on the reputation of the event organizer Event organizers who have previously created non-fraudulent event profiles may be less likely to create fraudulent event profiles in the future. Similarly, event organizers who have previously created fraudulent event profiles may be more likely to create fraudulent event profiles. Furthermore, new users 101 of event management system 170 may be more likely to create fraudulent event profiles than users 101 with a history of using the system. As an example and not by way of limitation, an event profile with an event organizer who has a history of creating non-fraudulent event profiles may have a lower fraud score than an event profile with an event organizer who has no history of creating event profiles. In particular embodiments, fraud detection system 160 may evaluate an event profile for fraud based on the payment history of the event organizer The payment history of an event organizer may include purchase information for one or more event profiles. The payment history of the event organizer may include the date, time, amount, and other suitable purchase information regarding prior pay outs to the organizer The payment history of the event organizer may also include the charge-back rate on any ticket payments that were paid out to the organizer Event organizers who have previously withdrawn funds may be less likely to create fraudulent event profiles than event organizers who are withdrawing funds for the first time. Moreover, event organizer who have previously withdrawn funds and had low charge-back rates are less likely to create fraudulent event profiles. As an example and not by way of limitation, an event profile with an event organizer who has had funds paid out to him several times previously may have a lower fraud score than an event profile with an event organizer who has not yet been paid out any funds. As another example and not by way of limitation, an event profile with an event organizer who has sold tickets associated with credit card payments and experienced a 0% charge-back rate may have a lower fraud score than an event profile with an event organizer who withdrew funds once previously and experienced a 50% charge-back rate. Although this disclosure describes evaluating an event profile for fraud based on particular event information, this disclosure contemplates evaluating an event profile for fraud based on any suitable event information.

In particular embodiments, fraud detection system 160 may evaluate an event profile for fraud based on the purchase information associated with the event profile. Purchase information may include the address verification system code for the payments for the event, the credit cards and credit-card types used to pay for the event, the decline rate for the credit cards, the use ratio (i.e., orders per card) of the credit cards, the locations of payers, the IP addresses of the payers, the use ratio of the IP addresses, the number of prior payouts to the event organizer, the amount of prior payouts to the event organizer, and other suitable purchase information. In particular embodiments, fraud detection system 160 may evaluate an event profile for fraud based on the address verification system codes (AVS codes) returned by the credit card processor for the payments for the event. When a user 101 purchases a ticket online using a credit card, a credit card processor may analyze the address information provided by the user 101 and compare it to the address of record for that credit card. The credit card processor may then determine that the address if a full match, a partial match, or a mismatch. Credit card charges that are full matches are less likely to be fraudulent than charges that are partial matches, which are less likely to be fraudulent than charges that are mismatches. Fraud detection system 160 may look at the AVS scores for all tickets purchased for an event profile. Event profiles with worse AVS scores (i.e., more partial matches and mismatches) may have higher fraud scores. As an example and not by way of limitation, an event profile with an AVS score of 0.84 (which is a good score) may have a lower fraud score than an event profile with an AVS score of 0.99 (which is a poor score). In particular embodiments, fraud detection system 160 may evaluate an event profile for fraud based on the payment or credit card decline rate for the payments for the event. Credit cards that have been stolen are more likely to be declined. Fraud detection system 160 may access all of the credit card transactions associated with an event profile and calculate a credit card decline rate for the event profile. As an example and not by way of limitation, an event profile with an 8% decline rate may have a lower fraud score than an event profile with a 42% decline rate. In particular embodiments, fraud detection system 160 may evaluate an event profile for fraud based on the locations of the payers of the payments for the event. Payers in particular locations or countries may be more likely to make fraudulent payment (such as, for example, by using stolen credit cards) than payers in other locations or countries. The location of a payer may be determined by querying the payer, from the payer's financial or personal information, by examining the IP address of the payer when he accesses event management system 170, or by other suitable methods. As an example and not by way of limitation, an event profile with several payers from Indonesia, where credit card fraud may be rampant, may have a higher fraud score than an event profile with payers only from the United States. In particular embodiments, fraud detection system 160 may evaluate an event profile for fraud based on the credit cards used to pay for the event and the use ratio of the credit cards. Payers who use a particular credit card multiple times to buy tickets for an event may be more likely to be using a stolen credit card than payers who are only using their credit cards once per event. Fraud detection system 160 may access all the credit card transaction associated with an event profile, identify any credit cards that were used multiple times, and calculate a credit card use ratio for the event profile. As an example and not by way of limitation, an event profile with a credit card use ratio of 4.1 (i.e., each credit card was used an average of 4.1 times to purchase tickets for the event) may have a higher fraud score than an event profile with a credit card use ratio of 1.3. In particular embodiments, fraud detection system 160 may evaluate an event profile for fraud based on the IP addresses used to make payments for the event and the use ratio of the IP addresses. Payers who are using the same IP address for several ticket orders for an event may be more likely to be using a stolen credit card than payers who place a single ticket order from a single IP address. As an example and not by way of limitation, a payer with seven stolen credit cards may access event management system 170 from a client system 130, wherein the client system 130 has a particular IP address associated with it. The payer may then use each stolen credit card once to purchase one ticket for the event. However, the IP address associated with each purchase may be same. Consequently, multiple transactions coming from the same IP address may be more likely to be fraudulent. Fraud detection system 160 may access all the IP addresses associated with ticket purchases for an event profile, identify any IP addresses that were used multiple times, and calculate an IP address use ratio for the event profile. As an example and not by way of limitation, an event profile with an IP use ratio of 6.0 (i.e., each IP address was used an average of 6.0 times to purchase tickets for the event) may have a higher fraud score than an event profile with an IP address use ration of 1.2. In particular embodiments, fraud detection system 160 may evaluate an event profile for fraud based on the number of prior payouts to the event organizer of the event. An event profile with an event organizer who has previously withdrawn funds may be less likely to be fraudulent than an event profile with an event organizer who has yet to withdraw funds. As an example and not by way of limitation, an event profile with an event organizer who has had funds paid out to him several times previously may have a lower fraud score than an event profile with an event organizer who has not yet been paid out any funds. In particular embodiments, fraud detection system 160 may evaluate an event profile for fraud based on the amount of the prior payouts to the event organizer of the event. An event profile with an event organizer who has previously received a large amount of funds may be less likely to be fraudulent than an event profile with an event organizer who has withdrawn less funds. As an example and not by way of limitation, an event profile with an event organizer who has had $10,000 in funds paid out to him may have a lower fraud score than an event profile with an event organizer who has not yet has any funds paid out. Although this disclosure describes evaluating an event profile for fraud based on particular event information or purchase information, this disclosure contemplates evaluating an event profile for fraud based on any suitable event information or purchase information.

In particular embodiments, fraud detection system 160 may evaluate an event profile for fraud based on the amount of funds to be paid out to an event organizer The amount of funds to be paid out may also be known as the amount “at-risk.” The amount at-risk may be evaluated on an absolute basis or a percentile basis. Event management system 170 may automatically pay out some or all of the funds associated with an event profile at a specific time period. As an example and not by way of limitation, event management system 170 may pay out the current balance of funds associated with an event profile on a weekly basis to the event organizer Alternatively, event management system 170 may receive a request to pay out some or all of the funds associated with an event profile to the event organizer As an example and not by way of limitation, the event organizer may transmit a request to withdraw all funds collected from ticket sales for an event. As another example and not by way of limitation, the event organizer may transmit a request to withdraw a fraction of the funds collected from tickets sales for the event. An event profile with an event organizer requesting a pay out of a large amount of funds or a large fraction of funds available may be more likely to be fraudulent than an event profile with an event organizer requesting a pay out of less funds or a smaller fraction of funds available. As an example and not by way of limitation, an event profile with an event organizer who is requesting to withdraw $100,000 may have a higher fraud score than an event profile with an event organizer who is requesting to withdraw $100. Alternatively, an event profile with an event organizer requesting a pay out of a large amount of funds or a large fraction of funds available may not necessarily be more likely to be fraudulent, however the larger pay-out request presents a higher risk to the operator of the event management system 170. In particular embodiments, fraud detection system 160 may evaluate an event profile based on the monetary risk posed by the amount of funds to be paid out to an event organizer. As an example, a request for $100,000 from a trusted event organizer may have the same fraud score as a request for $1000 from an unknown event organizer

In particular embodiments, fraud detection system 160 may approve or deny pay-out requests based on the fraud score of an event profile. Fraud detection system 160 may receive a request to pay out funds to an event organizer Fraud detection system 160 may then determine a fraud score for that event profile. If the fraud score for the event profile is greater than a threshold fraud score, then fraud detection system 160 may deny the request to pay out funds. As an example and not by way of limitation, if the fraud score for the event profile is in the 98th percentile or higher, fraud detection system 160 may automatically deny the request to pay out funds. However, if the fraud score for the event is less than a threshold fraud score, then fraud detection system 160 may approve the request to pay out funds. Event management system 170 may then facilitate the transfer of the requested fund to the event organizer

In particular embodiments, fraud detection system 160 may perform a variety of actions to counter improper activities once an event profile has been found fraudulent. As an example and not by way of limitation, fraud detection system 160 may deactivate the event management account associated with the event organizer who created a fraudulent event profile. As another example and not by way of limitation, fraud detection system 160 may stop ticket sales for an event associated with a fraudulent event profile.

In particular embodiments, fraud detection system 160 may display the results of its evaluation of an event profile for fraud. As an example and not by way of limitation, fraud detection system 160 may calculate a fraud score for a particular event profile and transmit that score to a client system 130, where it can be displayed by the client system 130 or viewed by a user 101. As another example and not by way of limitation, fraud detection system 160 may transmit a fraud score to event management system 170, where it can be viewed by a system administrator. As yet another example and not by way of limitation, fraud detection system 160 may transmit a fraud score (and possibly associated event information) to relevant law enforcement authorities. Although this disclosure describes displaying the evaluation of an event profile for fraud on particular systems, this disclosure contemplates displaying the evaluation of an event profile for fraud on any suitable system. As an example and not by way of limitation, the calculation of a fraud score may be displayed on client system 130, fraud detection system 160, event management system 170, another suitable system, or two or more such systems.

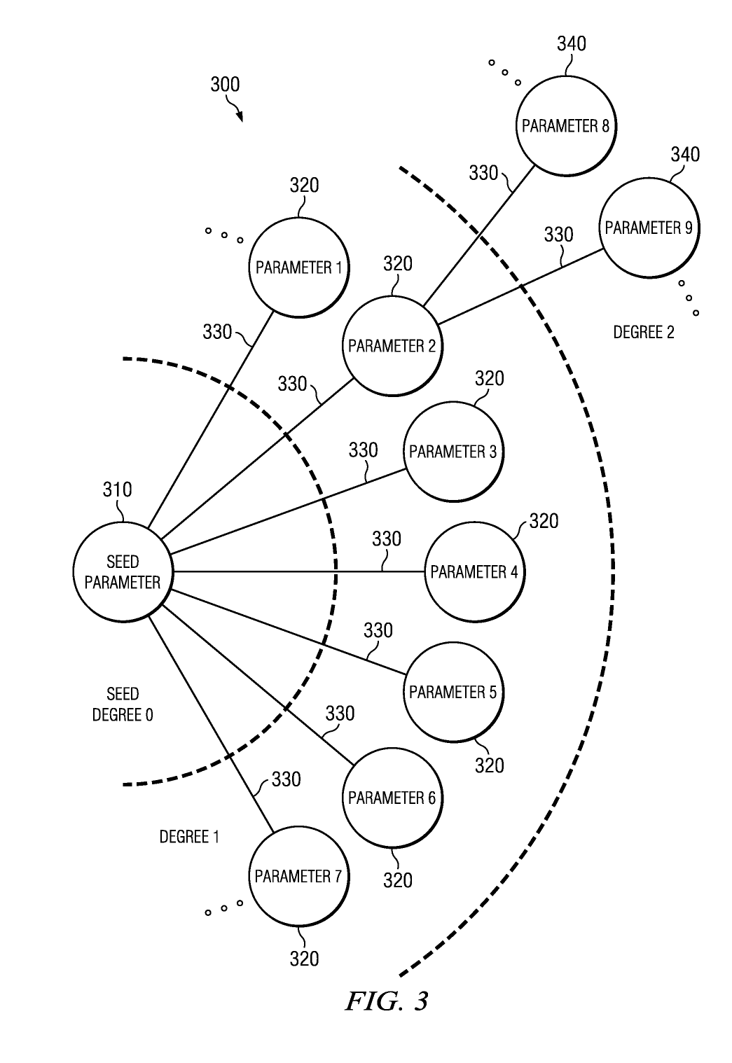

FIG. 2 illustrates an example method 200 for evaluating event profiles for fraud. The method begins at step 210, where fraud detection system 160 may access event information associated with an event profile. The event profile may be associated with a particular event. At step 220, fraud detection system 160 may access purchase information associated with the event profile. At step 230, fraud detection system 160 may calculate a fraud score for the event profile based at least in part on the event information and the purchase information. At step 230, to calculate the fraud score, fraud detection system 160 may first calculate an event quality score based on the event information and a payment quality score based on the purchase information, and then fraud detection system 160 may calculate a fraud score based at least in part on the event quality score and the payment quality score. At step 230, fraud detection system 160 may also access an amount of funds requested to be paid out to an event organizer and calculate the fraud score further based at least in part on the amount of funds requested to be paid out to the event organizer Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components carrying out particular steps of the method of FIG. 2, this disclosure contemplates any suitable combination of any suitable components carrying out any suitable steps of the method of FIG. 2.

### Detecting Fraud Using Relational Information

In particular embodiments, fraud detection system 160 may evaluate one or more event profiles for potential or actual fraud based on the relation of each event profile to a seed event profile that has already been identified as being associated with fraud. Fraud detection system 160 may identify links between event parameters, such as users, orders, and events, by identifying other related event parameters. These event parameters may be recursively examined a number of degrees from a seed event parameter, which may have previously been identified as being associated with fraud, to see if relationships back to the seed event parameter (or other known fraudulent event parameters) can be identified. Probabilistic link analysis involves using known associations between event parameters and computationally assigning weights to these. From there, fraud detection system 160 may process the network of event parameter to find other event parameters that have a high probability of being fraudulent as well. Fraud detection system 160 may access event profiles and associated event parameters on event management system 170 and analyze the event profiles for improper, fraudulent, or illegal use. Fraud detection system 160 may use any of the method described previously or subsequently to evaluate event parameters for fraud. As an example and not by way of limitation, an event parameter may include an event identifier (ID), an email address of a user, an IP address of a user, a user ID of a user, a credit card number of a user, a device ID of a user, the venue for the event, the event title, the event details, the description of the event, the geographic location of the event, purchase information for the event, another suitable event parameter, or any combination thereof. Although this disclosure describes particular methods for evaluating event profiles for fraud, this disclosure contemplates any suitable methods for evaluating event profiles for fraud. Moreover, although this disclosure describes particular event profiles with particular parameters, this disclosure contemplates any suitable event profiles with any suitable parameters.

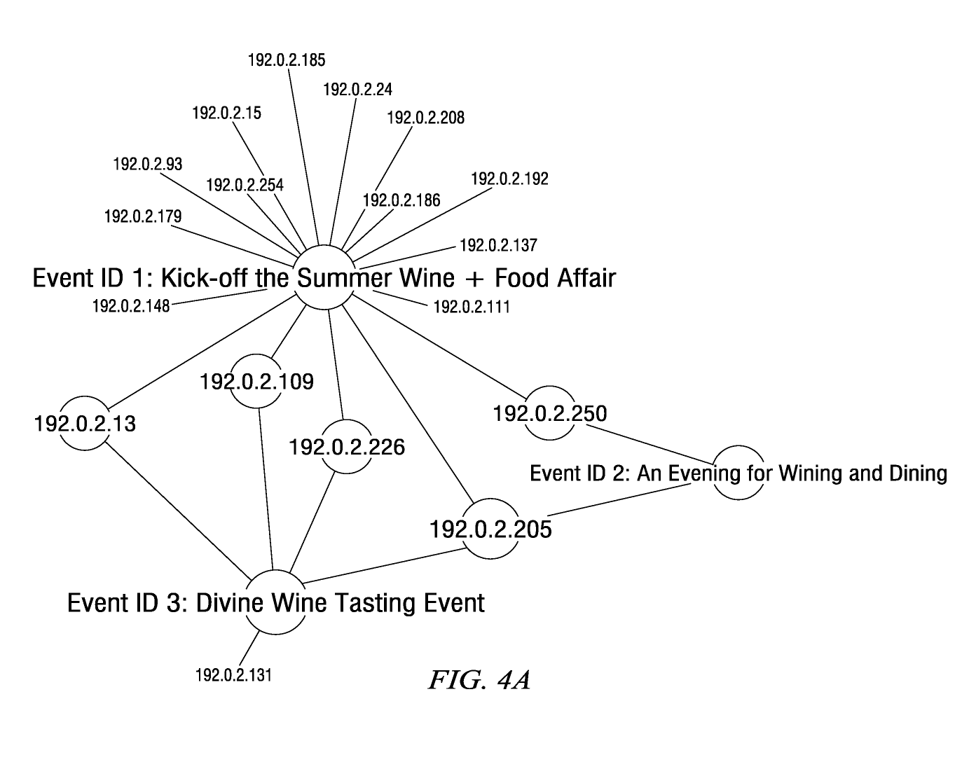

FIG. 3 illustrates an example graph 300 showing the relationship between various event parameters. Graph 300 includes a seed event parameter 310, a plurality of first-degree event parameters 320, and a plurality of second-degree event parameters 340 connected to each other by relations 330. The seed event parameter 310, first-degree event parameters 320, and second-degree event parameters 340 may be any suitable type of event parameter. In particular embodiments, a seed event parameter 310 may be related to one or more first-degree event parameters 320. Event parameters within the same event profile may be considered to be separated by one degree of separation from each other. Alternatively, event parameters for an event profile may be considered to be separated by one degree of separation from the event ID of that event profile. The seed event parameter 310 may be an event parameter that has been identified as being associated with fraud. As an example and not by way of limitation, a seed event parameter 310 may be an first event ID of a first event profile, where the event profile has been identified as being associated with fraud, and the first-degree event parameters 320 may be one or more of the other event parameters of the first event profile, such as, for example, the email address of the organizer, the IP address of the organizer, the bank account number of the organizer, the email address of a first attendee, and so on. In particular embodiments, each first-degree event parameter 320 may be related to one or more second-degree event parameters 340. Similarly, although not illustrated in FIG. 3, each second-degree event parameter 340 may be related to one or more third-degree event parameters, and so on. As an example and not by way of limitation, one of the first-degree event parameters 320 may be a first email address of the event organizer of the first event. The first email address of the first organizer may also be identical to a second email address of an attendee of a second event. In other words, the same person was both the organizer of the first event and an attendee of the second event, or at least the same email address was used in both cases. Thus, in this example a first-degree event parameter 320 may be the first email address of the first organizer, and the second-degree event parameters 340 may be one or more of the event parameters of the second event profile. Although FIG. 3 illustrates a particular arrangement of seed event parameter 310, first-degree parameters 320, second-degree event parameters 340, and relations 330, this disclosure contemplates any suitable arrangement of seed event parameter 310, first-degree parameters 320, second-degree event parameters 340, and relations 330. Moreover, although FIG. 3 illustrates a particular number of seed event parameters 310, first-degree parameters 320, second-degree event parameters 340, and relations 330, this disclosure contemplates any suitable number of seed event parameters 310, first-degree parameters 320, second-degree event parameters 340, and relations 330.

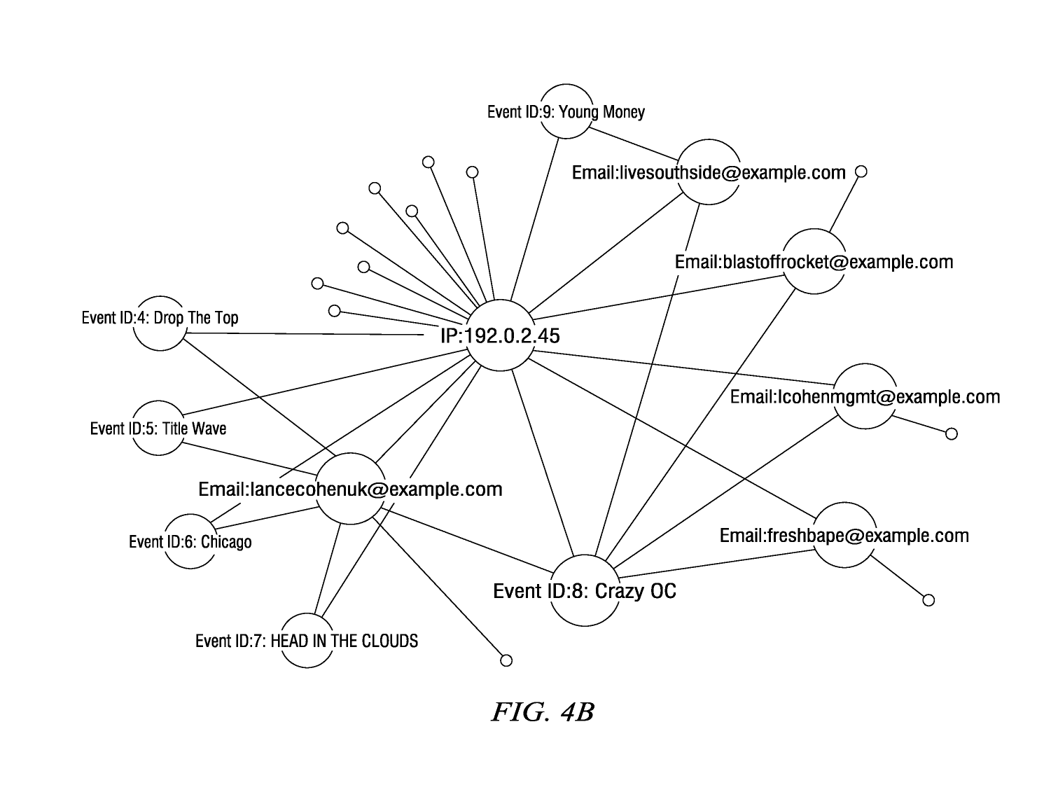

FIGS. 4A-4C illustrate example graphs showing the relationship between the event parameters of multiple event profiles. In FIGS. 4A-4C, a seed event parameter that had been identified as being associated with fraud was used to identify other event parameters that may also be associated with fraud. In FIG. 4A, the event profile for a first event, “Kick-off the Summer Wine+Food Affair,” was identified as being associated with fraud. Fraud detection system 160 used the event ID for the first event, “Event ID 1,” as a seed event parameter. Fraud detection system 160 then accessed the related first-degree event parameters, which included the IP addresses of attendees of the first event. Several of these IP addresses, “192.0.2.13,” “192.0.2.109,” “192.0.2.226,” “192.0.2.205,” and “192.0.2.250,” were also the same IP addresses used by attendees of two second events, “An Evening for Wining and Dining” and “Divine Wine Tasting Event,” which had second event IDs “Event ID 2” and “Event ID 3,” respectively. Fraud detection system 160 then identified these second event IDs as being associated with fraud based on their relation to the IP addresses that were related to the first event ID. Similarly, in FIG. 4B, a first IP address, “192.0.2.45,” was identified as being associated with fraud. Fraud detection system 160 then used the first IP address as a seed parameter and accessed the related event parameters. The first IP address was related to various email addresses and event IDs, and the email address and event IDs were also related to each other (that is, these email addresses were associated with attendees of these events). Fraud detection system 160 then identified these email address and event IDs as being associated with fraud based on their relation to the seed event parameter. In FIG. 4C, the event profile for a first event, “Fraud_Event,” was identified as being associated with fraud. Fraud detection system 160 used the event ID for the first event as a seed event parameter. Fraud detection system 160 then accessed the related first-degree event parameters, which included the email address and IP address of users associated with the first event (including both the organizer and attendees). The organizer's email address and the IP address of one of the attendees were also related to the event ID for a second event, “Event_{—}2.” Fraud detection system 160 then identified this second event ID as being associated with fraud based on its relation to the email address of the organizer of the first event and the IP address of the attendee of the first event. Although FIGS. 4A-4C illustrate particular event parameters with particular attributes and particular relations, this disclosure contemplates any suitable event parameters having any suitable attributes and any suitable relations. Furthermore, although FIGS. 4A-4C illustrate and this disclosure describes representing event parameters in a particular manner, this disclosure contemplates representing event parameters in any suitable manner. As an example and not by way of limitation, an event parameter may be a field in a relational database.

In particular embodiments, fraud detection system 160 may construct a graph structure (such as, for example, the graphs illustrated in FIGS. 4A-4C) representing a seed event parameter and its related event parameters. The graph structure may comprise a relational set of nodes, where each node represents a value of an event parameter. As an example and not by way of limitation, fraud detection system 160 may first receive a first value corresponding to an event parameter. A seed node may then be created having the first value. Fraud detection system 160 may then analyze selected types of event parameters in a first set of event profiles to look for a first set of event parameters with values equal to the first value. After fraud detection system 160 finds the first set of event parameters with values equal to the first value, it may then identify second set of event profiles associated with the first set of event parameters (i.e., identify the event profiles that include these event parameters). Fraud detection system 160 may then create a first set of nodes representing selected types of event parameters in the second set of event profiles, where the first set of nodes is connected by one degree of separation to the seed node. This process may be repeated to create additional set of nodes. The nodes may then be analyzed for fraud based on their relation to the seed node. As another example and not by way of limitation, a graph structure representing the seed event parameter and its related event parameters may be computed by an algorithm described by the following pseudocode:

```
ITERATION_COUNT = 0
message = “initial suspicious/fraudulent event”
SELECT ‘original’ as source_value, e.id as target_value
FROM Events e
WHERE e.id = <SEED_EVENT_ID>
store_to_database(results_of_query, iteration_count, message)
FOR 1...ITERATION_COUNT:
  #link source 1
  message = “event attended with linked email address”
  SELECT a.email as source_value, a.event as target_value
  FROM Event_Attendees a
  WHERE a.email in (<list_of_all_email_addresses_from_previous_
  iteration>)
  store_to_database(results_of _query, iteration_count, message)
  #link source 2
  message = “event has order from from linked ip”
  SELECT o.ip_address as source_value, o.event as target_value
  FROM Placed_Orders o
  WHERE o.ip_address in (<list_of_all_ip_addresses_from_previous_
  iteration>)
  store_to_database(results_of_query, iteration_count, message)
  #link source 3
  message = “event has order from from linked email address”
  SELECT o.email as source_value, o.event as target_value
  FROM Orders o
  WHERE o.email in (<list_of_all_email_addresses_from_previous_
  iteration>)
  store_to_database(results_of_query, iteration_count, message)
  #link source 4
  message = “event created by linked user”
  SELECT u.email as source_value, e.id as target_value
  FROM Users u join Events e on e.uid = u.id
  WHERE u.email in (<list_of_all_email_addresses_from_previous_
  iteration>)
  store_to_database(results_of_query, iteration_count, message)
  #link source 5
  message = “ip address for linked order”
  SELECT o.event as source_value, o.ip_address as target_value
  FROM Orders o
  WHERE o.event in (<list_of_all_events_from_previous_iteration)
  store_to_database(results_of_query, iteration_count, message)
```

Although this disclosure describes accessing and analyzing event parameters in a particular manner, this disclosure contemplates accessing and analyzing event parameters in any suitable manner.

In particular embodiments, fraud detection system 160 may evaluate an event parameter for potential or actual fraud by calculating a fraud score for the event parameter. A fraud score may represent the probability an event parameter is fraudulent or is associated with fraud, the percentile rank of the risk of fraud associated with the event parameter in relation to other event parameters, or other suitable scoring representations. In particular embodiments, the fraud score for an event parameter may be a percentile rank equal to the percentage of event parameters that have a fraud score the same or lower than the event parameter. As an example and not by way of limitation, fraud detection system 160 may identify a particular event profile as being associated with fraud. Fraud detection system 160 may then analyze one or more event parameters of the event profile and calculate a preliminary fraud value associated with the risk of fraud for each event parameter. Fraud detection system 160 may then sort the event parameters by their preliminary fraud value and calculate a percentile rank associate with each event parameter or preliminary calculated fraud value. The percentile ranks may then be used as the fraud scores for the event parameters. Although this disclosure describes using particular methods for scoring the risk of fraud associated with an event parameter, this disclosure contemplates using any suitable methods for scoring the risk of fraud associated with an event parameter.

In particular embodiments, fraud detection system 160 may calculate a fraud score for an event parameter based on one or more factors, such as, for example, the attributes of the event parameter, the relation of the event parameter to other event parameters, the fraud score of one or more other event parameters, other suitable factors, or any combination thereof. The following is an example algorithm that fraud detection system 160 could use to calculate a fraud score:

s₁=f(E₁, E₂, . . . , Eₙ, s₂, . . . , sₙ, r_{1,2} . . . , r_{1,n})

where:
s₁ is the fraud score for a first event parameter,
E₁ is the event attributes of the first event parameter,
E₂, . . . , Eₙ are event attributes of second event parameters 2 through n,
s₂, . . . , sₙ are the fraud scores for second event parameters 2 through n, and
r_{1,2}, . . . , r_{1,n} are the relations of the first event parameter to second event parameters 2 through n.

Although this disclosure describes calculating a fraud score using a particular algorithm, this disclosure contemplates calculating a fraud score using any suitable algorithm. Moreover, although this disclosure describes calculating a fraud score using particular variables that represent particular parameters, this disclosure contemplates calculating a fraud score using any suitable variables representing any suitable parameters.

In particular embodiments, fraud detection system 160 may use a variety of scales, both qualitative and quantitative, for representing a fraud score for an event parameter. As an example and not by way of limitation, fraud detection system 160 could assign fraud scores using a 0-to-4 rating scale, where the five-level rating scale may be:

0. Known legitimate event parameter;

1. Minor fraud risk;

2. Moderate fraud risk;

3. High fraud risk;

4. Known fraudulent event parameter.

As another example and not by way of limitation, fraud detection system 160 may calculate the fraud score for an event parameter on a scale of 0 to 1, where 0 indicates that the event parameter is known to be legitimate, while a 1 indicates that the event parameter is known to be fraudulent. Although this disclosure describes particular scales for representing fraud scores, this disclosure contemplates any suitable scales for representing fraud scores.

In particular embodiments, fraud detection system 160 may calculate the fraud score for an event parameter based on the attributes of the event parameter. An event parameter may have one or more attributes. An attribute of an event parameter may include a type of the parameter, a value of the parameter, a multiplicity of the value of the parameter, a degree of separation of the parameter from one of the seed parameters, a cardinality of the value of the parameter, a relative frequency of the parameter value in legitimate versus fraudulent events, another suitable attribute, or any combination thereof. As an example and not by way of limitation, an event profile for the event “An Evening for Wining and Dining” may have an event ID with a value of “Event ID 2.” As another example and not by way of limitation, a first event profile may have an IP address of an attendee with a multiplicity of 25 (i.e., 25 attendees of the event are associated with the same IP address). If a second event profile has the same IP address of the attendee with a multiplicity of 10, then that parameter may be considered to have a multiplicity of 35 across the plurality of event profiles. Alternatively, if the second event profile has the same IP address as the IP address of the organizer, then that IP address may be considered to have a multiplicity of 26. In particular embodiments, certain types of event parameters may have a higher fraud score than other types of event parameters. Particular types of event parameters may be particular strong indicators of fraud risk, while other types of event parameters may be weak indicators of fraud risk. As an example and not by way of limitation, an IP address of a user (e.g., an attendee or organizer) may have a relatively weak correlation to fraud score because IP addresses can be shared between users. The multiplicity of a particular event parameter value may be a strong indicator of fraud risk. As an example and not by way of limitation, if a high number of fraudulent users share an IP address, then the IP address may have a relatively high fraud score. This is because fraudsters tend to reuse things, such as email addresses, devices, passwords, bank account numbers, credit card numbers, etc. However, multiplicity is not always a predictor of fraud risk. Multiple legitimate users may share an IP address, and the more legitimate users that share an IP address (i.e., the greater the multiplicity of the IP address), the lower the fraud score for that IP address may be. Similarly, an IP address used by numerous legitimate users and a single fraudulent user may have a relatively low fraud score. Other event parameter attributes may also be strong indicators of fraud risk. As another example and not by way of limitation, an email address of a user (e.g., an attendee or organizer) may have a relatively strong correlation to a fraud score because email addresses are generally not shared between users. Therefore, an email address for a known fraudulent user may have a high fraud score, while an email address for a user that has not been identified as being associated with fraud may have a low or zero fraud score. As yet another example and not by way of limitation, a financial account identifier (e.g., a PAYPAL username or a bank account number) may have a relatively strong correlation to fraud score because financial accounts are not generally shared between users. Therefore, a PAYPAL username for a known fraudulent user may have a high fraud score, while a bank account number for a user that has not been identified as being associated with fraud may have a low or zero fraud score. Although this disclosure describes calculation fraud scores for particular event parameter based on particular attributes, this disclosure contemplates calculating fraud scores for any suitable event parameters in any suitable attributes.

In particular embodiments, fraud detection system 160 may calculate the fraud score for an event parameter based on the relation of the event parameter to one or more other event parameters. The relation of a first event parameter to a second event parameter may include the degree of separation between the two event parameters, the type of each parameter, the attributes of each parameter, or any combination thereof. In particular embodiments, event parameters may be related to each other because they are from the same event profile. As an example and not by way of limitation, a first event ID of a first event profile and a first email address of the organizer of the first event profile may be considered related because they are from the same event profile. In particular embodiments, different event profiles may be considered related by sharing the same event parameter. In other words, if two separate event parameters from two separate event profile both have the same value, those event profiles (and thus the event parameters associated with those event profiles) may be considered related. As an example and not by way of limitation, a first event profile may have an email address of the organizer with a value of “lancecohenuk@example.com,” and a second event profile may have an email address of the organizer with the same value. In particular embodiments, different event profiles may be considered related by having different types of event parameters with the same attributes. As an example and not by way of limitation, a first event profile may have an email address of the organizer with a value of “blastoffrocket@example.com,” and a second event profile may have an email address of an attendee with the same value. In particular embodiments, the fraud score for a first event parameter may be based on the relation between first event parameter and one or more second event parameters. Particular relations between event parameters may be particular strong indicators of fraud risk, while other relations between event parameters may be weak indicators of fraud risk. As an example and not by way of limitation, a first event parameter that is related to a seed event parameter (i.e., an event parameter that has been identified as being associated with fraud) by one degree of separation may have a higher fraud score than a second event parameter that is related to the seed event parameter by two degrees of separation because the first event parameter is more closely related to the seed event than the second event parameter. Although this disclosure describes calculating a fraud score for an event parameter based on particular relations, this disclosure contemplates calculating fraud scores for event parameters based on any suitable relations.

In particular embodiments, the fraud detection system 160 may calculate the fraud score for an event parameter based on the fraud score for one or more other event parameters. The fraud score for a first event parameter may be based on the fraud score of one or more second event parameters that are related to the first event parameter. As an example and not by way of limitation, if the email address of a user has a high fraud score, then the bank account number of the user may also have a relatively high fraud score. As another example and not by way of limitation, if an event ID has a low fraud score, then the email address of the organizer of the event may also have a relatively low fraud score. As yet another example and not by way of limitation, if an IP address has a low fraud score, then an event ID related to that IP address may have a relatively low fraud score. However, if an IP address has a high fraud score (e.g., because it is associated with a known fraud event), then an event ID related to that IP address may have a relatively high fraud score because of it's association with the IP address. But if an IP address is associated with one known fraud event, 100 legitimate events, and one event of unknown status, then the event of unknown status may receive a relatively low fraud score, notwithstanding being associated with an IP address associated with a known fraud event, because the relatively ratio of fraud to legitimate associated with that IP address is low. Although this disclosure describes calculating fraud scores for event parameters in a particular manner, this disclosure contemplates calculating fraud scores for event parameters in any suitable manner.

In particular embodiments, after a first event profile has been identified as being associated with fraud, fraud detection system 160 may identify related event profiles as being associated with fraud. Event profiles may be related because they share particular attributes. As an example and not by way of limitation, two event profiles may be related because they share the same event organizer In this case, the event IDs for the two event profiles are separated by two degrees of separation. As another example and not by way of limitation, two event profiles may be created by different event organizer, but may still be related because they are both associated with the same bank account number. In other words, multiple fraudsters may be sharing the same bank account number. Also in this case, the event IDs for the two event profiles are again separated by two degrees of separation. An event profile that is related to seed event profile (i.e., an event profile that has been identifies as being associated with fraud) may be identified as being fraudulent based on its relation to the seed event profile. As an example and not by way of limitation, if a first event with a first event organizer has been identified as fraudulent, then fraud detection system 160 may assume that other events created by the first event organizer are more likely to be fraudulent. As such, fraud detection system 160 may determine which other events were created by the first event organizer and identify those events as having a relatively risk of being fraudulent, and thus may calculate a relatively high fraud score for those events. This type of analysis can be expanded by looking at other types of event parameters in a first event profile. As an example and not by way of limitation, a first event profile may have been identifies as being associated with fraud, and that first event profile may have been created by a first user with an email address of “ABC@example.com” and a PAYPAL username of “ABC@example.com.” Fraud detection system 160 may then determine that these event parameters have a relatively high fraud score based on their relation to the first event profile. A second event profile may then be created by a second user with an email address of “DEF@example.com” and a PAYPAL username of “ABC@example.com.” In other words, the first and second event profiles may appear to be created by different users because they are associated with different user email addresses, it is likely that they are both associated with the same fraudster because both associated with the PAYPAL username “ABC@example.com,” which has already been identified as being associated with fraud. Therefore, based on the relation to the PAYPAL username “ABC@example.com,” the second user's email address, “DEF@example.com,” may be given a relatively high fraud score. Although this disclosure describes identifying particular event profiles and event parameters as being associated with fraud, this disclosure contemplates identifying any suitable event profiles and event parameters as being associated with fraud. Moreover, although this disclosure describes identifying event profiles and event parameters as being associated with fraud in a particular manner, this disclosure contemplates identifying event profiles and event parameters as being associated with fraud in any suitable manner.

In particular embodiments, fraud detection system 160 may access a first event profile for a first event. The first event profile may include at least one seed event parameter, wherein each seed event parameter has been identified as being associated with fraud. As an example and not by way of limitation, the first event profile may have been identified as being associated with fraud by analyzing the event information, purchase information, and amount at-risk, as described previously. The first event profile may also include one or more first event parameters, and each first event parameter may be related to a seed event parameter by not more than one degree of separation. As an example and not by way of limitation, the seed event parameter may be an event ID of a first event, and the first event parameters may include an email address of a first attendee of the first event, an email address of a second attendee of the first event, an IP address of the first attendee, and an IP address of the second attendee. As another example and not by way of limitation, the seed event parameter may be an email address of an organizer of a first event, and the first event parameters may include the IP address of the organizer, the bank account number of the organizer, and the event ID of the first event. Although this disclosure describes accessing particular event parameters of particular event profiles, this disclosure contemplates any suitable event parameters of any suitable event profiles.

In particular embodiments, fraud detection system 160 may calculate a fraud score for each of the first event parameters based on the attributes of the first event parameter and the relation of the first event parameter to the seed event parameters. An event profile that has been identified as being fraudulent may comprise one or more event parameters, and each event parameter of the fraudulent event profile may be evaluated for fraud. Particular types of event parameters may be particular strong indicators of fraud risk, while other types of event parameters may be weak indicators of fraud risk. Similarly, particular relations between event parameters may be particular strong indicators of fraud risk, while other relations between event parameters may be weak indicators of fraud risk. As an example and not by way of limitation, a first event parameter that is an email address of an organizer may have an higher fraud risk score than a first event parameter that is an email address of an attendees because event parameters associated with the organizer of a fraudulent event may be stronger indicators of fraud risk than event parameters associated with mere attendees of an event. As another example and not by way of limitation, a first event parameter that is an email address of an organizer may have an higher fraud risk score than a first event parameter that is an IP address of an organizer email address tend to be stronger indicators of fraud risk than IP addresses. Although this disclosure describes calculating fraud scores for particular event parameters in a particular manner, this disclosure contemplates calculating fraud scores for any suitable event parameters in any suitable manner.

In particular embodiments, fraud detection system 160 may access one or more second event profiles for one or more second events, respectively. Each second profile may include one or more second event parameters. One or more of the second event parameters for each second profile may correspond to one or more of the first event parameters of the first event profile, and each second event parameter may be related to a seed event parameter by not more than two degrees of separation. In other words, the second event profiles consist of event profiles that have an event parameter with the same value as one of the event parameters of the first event profile. The event parameter that relates the first event profile to the second event profile may or may not be the same type of event parameter with respect to each event profile. As an example and not by way of limitation, a first event profile may have an email address of an attendee with a value of “user@example.com,” and a second event profile may have an email address of an attendee with the same value. As another example and not by way of limitation, a first event profile may have an IP address of an organizer with a value of “192.0.2.109,” and a second event profile may have an IP address of an attendee with the same value. In this case, the type of event parameter in each event profile is different, but because the value of the event parameter is the same for both event parameters, this event parameter value may be used to relate the respective event profiles. Although this disclosure describes accessing particular event parameters of particular event profiles, this disclosure contemplates any suitable event parameters of any suitable event profiles.

In particular embodiments, fraud detection system 160 may calculate a fraud score for each of the second event parameters based on the attributes of the second event parameter, the relation of the second event parameter to the first event parameters, and the fraud scores of the first event parameters. As an example and not by way of limitation, a second event parameter that is related to two first event parameters (e.g., connected by an edge in a graph structure) may have a higher fraud score than a second event parameter that is related to only one first event parameter because event parameters with a higher multiplicity may be a stronger indicator of fraud risk than an event parameter with a low or single multiplicity. As another example and not by way of limitation, a second event parameter that is an bank account of an organizer may have a higher fraud risk score than a second event parameter that is an email address of the organizer because bank account numbers tend to be stronger indicators of fraud risk than email addresses. Although this disclosure describes calculating fraud scores for particular event parameters in a particular manner, this disclosure contemplates calculating fraud scores for any suitable event parameters in any suitable manner.

In particular embodiments, fraud detection system 160 may identify one or more second event parameters of the second event profiles as being associated with fraud based on the fraud score for each of the second event parameters. An event parameter may be flagged, marked, or modified so that fraud detection system 160, event management system 170, or another suitable system can identify the event parameter as being associated with fraud. In particular embodiments, fraud detection system 160 may identify a second event parameter as being associated with fraud by determining whether the fraud score for the second event parameter is greater than a threshold fraud score. As an example and not by way of limitation, if the threshold fraud score is 0.80, then a first event ID with a fraud risk score of 0.5 may not be identified as being associated with fraud, while a second event ID with a fraud risk score of 0.92 may be identified as being associated with fraud. In particular embodiments, after an event parameter is identifies as being associated with fraud, that event parameter may now serve as a seed event parameter for iteratively performing the fraud detection process. In this case, the fraud score for the event parameter may be reset to the maximum fraud score. As an example and not by way of limitation, if a event ID with a calculated fraud score of 0.92 on a 0-to-1 scale is identified as being associated with fraud, fraud detection system 160 may then reset the fraud score for that event parameter to 1.0. Fraud detection system 160 may then recalculate the fraud scores for other event parameters, effectively repeating the process described previously. This may be used to identify even more fraudulent event parameters. Although this disclosure describes identifying particular event parameters as being associated with fraud in a particular manner, this disclosure contemplates identifying any suitable event parameters as being associated with fraud in any suitable manner.

In particular embodiments, fraud detection system 160 may approve or deny requests to pay out funds associated with an event profile that includes an event parameter that has been identified as associated with fraud. Fraud detection system 160 may receive a request to pay out funds for a first event to the event organizer. Fraud detection system 160 may then determine a fraud score for the event parameters of the event profile for the first event. If the fraud score for one or more of the event parameters of the event profile is greater than a threshold fraud score, then fraud detection system 160 may deny the request to pay out funds. As an example and not by way of limitation, if the fraud score for the bank account number of the event organizer is in the 98th percentile or higher, fraud detection system 160 may automatically deny the request to pay out funds. However, if the fraud score for the bank account number of the event organizer is less than a threshold fraud score, then fraud detection system 160 may approve the request to pay out funds. Event management system 170 may then facilitate the transfer of the requested fund to the event organizer Although this disclosure describes fraud detection system 160 performing particular actions based on identifying an event parameter associated with fraud, this disclosure contemplates any suitable actions based on identifying an event parameter associated with fraud. As an example and not by way of limitation, fraud detection system 160 may cancel or delete event profiles or user accounts associated with the fraudulent event parameter, report fraudulent users to the appropriate authorities, monitor event organizer activities, delay or restrict future payouts, freeze funds, change payment details, automatically reset the password for the account, block one or more associated IP addresses, perform additional investigations by specialists, share this information with anti-fraud networks, perform another suitable action, or any combination thereof.

In particular embodiments, fraud detection system 160 may transmitting the calculated fraud score for an event parameter for presentation to a user. As an example and not by way of limitation, fraud detection system 160 may calculate a fraud score for a particular event parameter and transmit that fraud score to a client system 130, where it can be displayed by the client system 130 or viewed by a user 101. As another example and not by way of limitation, fraud detection system 160 may transmit a fraud score to event management system 170, where it can be viewed by a system administrator. As yet another example and not by way of limitation, fraud detection system 160 may transmit a fraud score (and possibly associated event parameter attributes) to relevant law enforcement authorities. Although this disclosure describes transmitting fraud scores to particular systems for presentation to particular users, this disclosure contemplates transmitting fraud scores to any suitable systems for presentation to any suitable users. As an example and not by way of limitation, the calculation of a fraud score may be transmitted to client system 130, fraud detection system 160, event management system 170, another suitable system, or two or more such systems, for presentation to any suitable user.

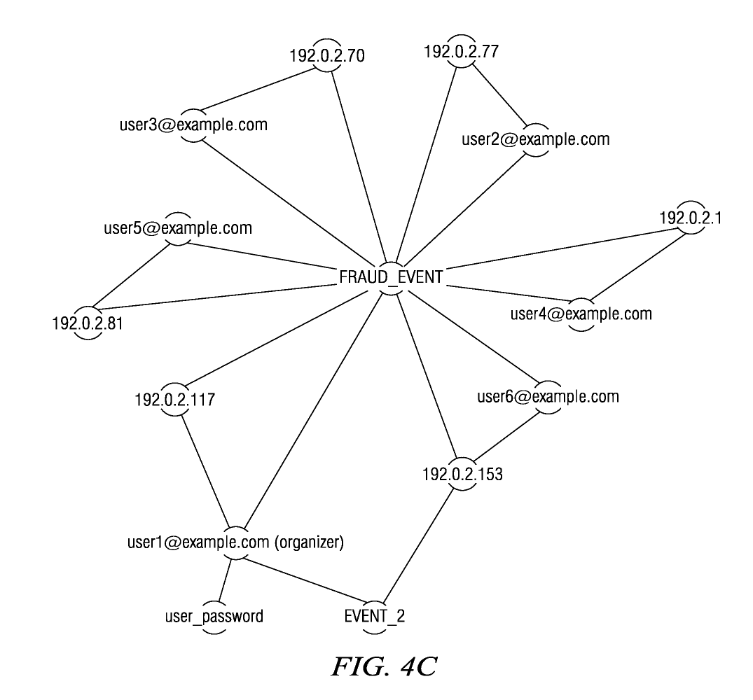

FIG. 5 illustrates an example graph 500 showing the calculation of fraud scores for various event parameters. In FIG. 5, the event parameter “Event ID 1” was identified as being associated with fraud, and thus may serve as a seed event parameter 510. Because the seed event parameter 510 has already been identified as being associated with fraud, it may be given a fraud score of s=1.0. “Event ID 1” is the event ID for a first event profile. Fraud detection system 160 may then access one or more additional event parameters from the first event profile. In this example, the event parameters accessed are “Attendee 1's Email Address” 522, “Organizer's IP Address” 524, and “Organizer's Email Address” 526, which are all event parameters of the first event profile and are related to the seed event parameter 510 by one degree of separation. Fraud detection system 160 may then calculate a fraud score for each of the first degree event parameters 522, 524, and 526 based on the attributes of the parameter and the relation of the parameter to the seed event parameter 510. The following is an example algorithm that fraud detection system 160 could use to calculate a fraud score for a first degree event parameter:

s₁=f(E₁, E₂, . . . , Eₙ, r_{1,2} . . . , r_{1,n})

where:
s₁ is the fraud score for a first degree event parameter,
E₁ is the event attributes of the first degree event parameter,
E₂, . . . , Eₙ are event attributes of seed event parameters 2 through n, and
r_{1,2}, . . . , r_{1,n} are the relations of the first degree event parameter to the seed event parameters 2 through n.

As an example and not by way of limitation, in FIG. 5, the fraud score for a first degree event parameter may be calculated using the equation s₁=(E₁·E_{seed}·r_{1,seed}), where E₁=0.2 for IP addresses, 0.5 for email addresses of attendees, and 0.9 for email addresses of organizers, and where E_{seed}=1 and r_{1,seed}=1 for first degree event parameter, 1 for second degree event parameters, and 0.5 for third degree event parameters. Therefore, the fraud score for “Attendee 1's Email Address” 522 would be calculated to be s₅₂₂=(E₅₂₂·E_{seed}·r_{522,seed})=(0.5·1·1)=0.5. Using the same algorithm, fraud detection system 160 would calculate a fraud score of 0.2 for “Organizer's IP Address” 524, and 0.9 for “Organizer's Email Address” 526. Next, fraud detection system 160 may access one or more second event profiles that contain event parameters with values equal to the values of the first degree event parameters. In this example, the event parameters accessed are “Event ID 2” 542 and “Event ID 3” 544, which are event parameters of a second and third event profile, respectively. As illustrated in FIG. 5, “Event ID 2” 542 is related to “Attendee 1's Email Address” 522, which means that “Attendee 1's Email Address 522” has an event parameter value that appears in both the first and second event profiles. Fraud detection system 160 may then calculate a fraud score for each of the second degree event parameters 542 and 544 based on the attributes of the parameter, the relation of the parameter to the seed event parameter 510, and the fraud score of first event parameters. The following is an example algorithm that fraud detection system 160 could use to calculate a fraud score for a second degree event parameter:

s₁=f(E₁, E₂, . . . , Eₙ, s₂, . . . , sₙ, r_{1,2} . . . , r_{1,n})

where:
s₁ is the fraud score for a second degree event parameter,
E₁ is the event attributes of the second degree event parameter,
E₂, . . . , Eₙ are event attributes of first degree event parameters 2 through n,
s₂, . . . , sₙ are the fraud scores for first degree event parameters 2 through n, and
r_{1,2}, . . . , r_{1,n} are the relations of the second degree event parameter to first degree event parameters 2 through n.

As an example and not by way of limitation, in FIG. 5, the fraud score for a second degree event parameter may be calculated using the equation s₁=(E₁·s₂ . . . , sₙ, ·r_{1,2}), where E₁=1.0 for event IDs, and where r_{1,2}=1 for second degree event parameters, and 0.5 for third degree event parameters. Therefore, the fraud score for “Event ID 2” 542 would be calculated to be s₅₄₂=(E₅₄₂·s₅₂₂, ·r_{542,522})=(1·0.5·1)=0.5. As another example and not by way of limitation, the fraud score for a second degree event may be calculated using the equation

$${s}_{1} = \sqrt[m]{{\sum }_{z = 2}^{n} {( {S}_{z} )}^{m}} \cdot ( {E}_{1} ) \cdot {\prod }_{z = 2}^{n} {r}_{1 , z} ,$$

where m=the multiplicity of the second degree event parameter (therefore, m=2, since it is related to both event parameters 524 and 526), s_{z} is the fraud score of first degree event parameter z, E₁=1.0 for event IDs, r_{1,z}=1 for second degree event parameters, and 0.5 for third degree event parameters, and s₁=1 for any s>1. Therefore, the fraud score for “Event ID 3” 544 would be calculated to be s₅₄₄=2\sqrt{(0.2)²+(0.9)²}·(1)·[1·1]=0.92. Although FIG. 5 illustrates particular event parameters with particular attributes and particular relations, this disclosure contemplates any suitable event parameters having any suitable attributes and any suitable relations. Furthermore, although FIG. 5 illustrates and this disclosure describes representing event parameters in a particular manner, this disclosure contemplates representing event parameters in any suitable manner.

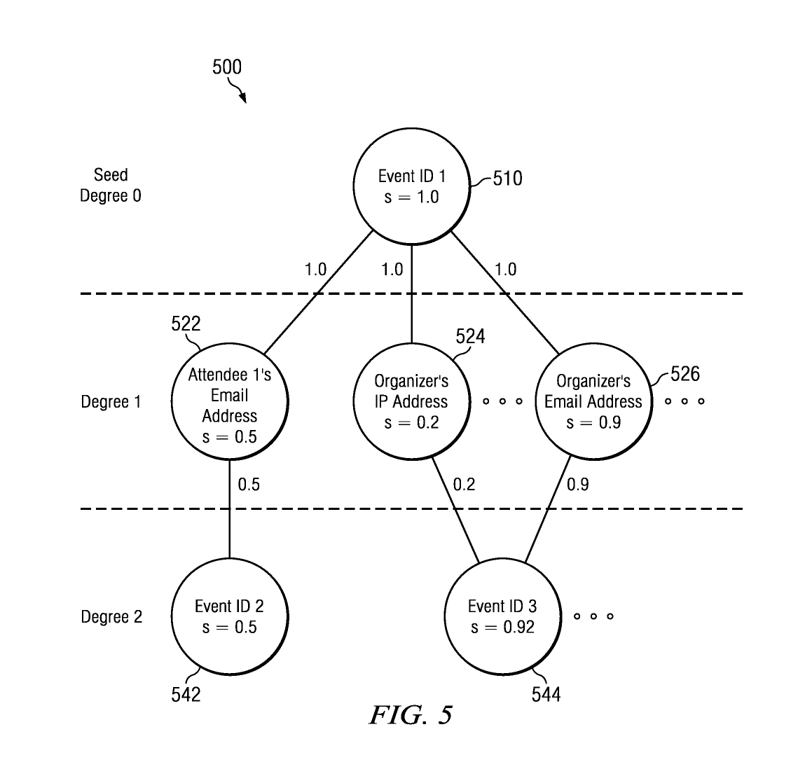

FIG. 6 illustrates an example method 600 for detecting fraud using relational information. The method begins at step 610, where fraud detection system 160 may access a first event profile for a first event. The first event profile may comprise at least one seed event parameter and one or more first event parameters, where each seed event parameter may have been identified as being associated with fraud. Each first event parameter may be related to one of the seed event parameter by one degree of separation. At step 620, fraud detection system 160 may calculate a fraud score for each of the first event parameters based on one or more attributes of the first parameter and the relation of the first parameter to one or more of the seed parameters. At step 630, fraud detection system 160 may access one or more second event profiles for one or more second events, respectively. Each second profile may comprise one or more second event parameters, and one or more of the second parameters for each second profile may correspond to one or more of the first parameters. Each second event parameter may be related to one of the seed event parameters by no more than two degrees of separation. At step 640, fraud detection system 160 may calculate a fraud score for each of the second event parameters based on one or more attributes of the second event parameter, the relation of the second event parameter to the first event parameters, and the fraud scores of the first event parameters. At step 650, fraud detection system 160 may identify at least one second event parameter as being associated with fraud based on the fraud scores for the second event parameters. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates particular components carrying out particular steps of the method of FIG. 6, this disclosure contemplates any suitable combination of any suitable components carrying out any suitable steps of the method of FIG. 6.

### Systems and Methods

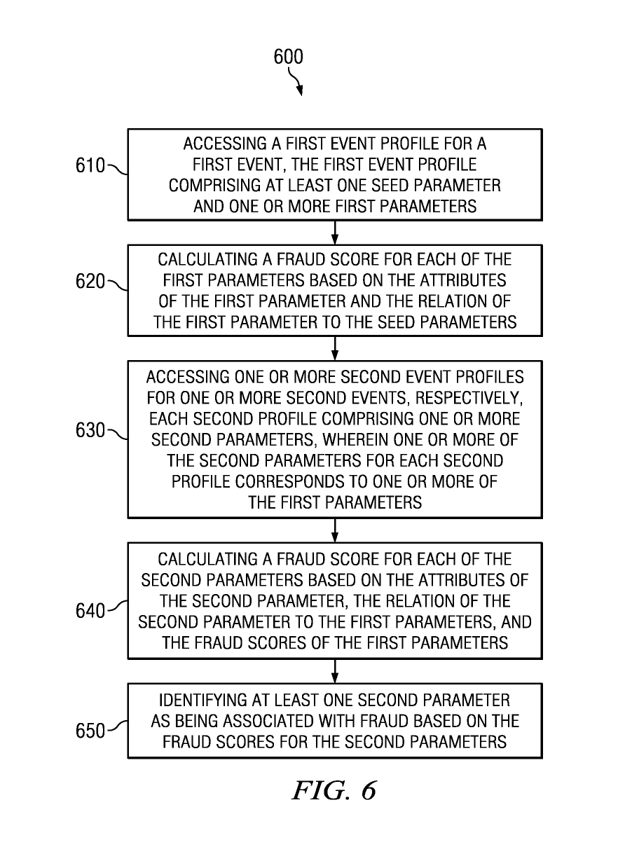

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, reference to a computer-readable non-transitory storage medium may include a semiconductor-based or other integrated circuit (IC) (such as, for example, a field-programmable gate array (FPGA) or an application-specific IC (ASIC)), a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, another suitable computer-readable non-transitory storage medium, or a suitable combination of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 702 (such as, for example, one or more internal registers or caches), one or more portions of memory 704, one or more portions of storage 706, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

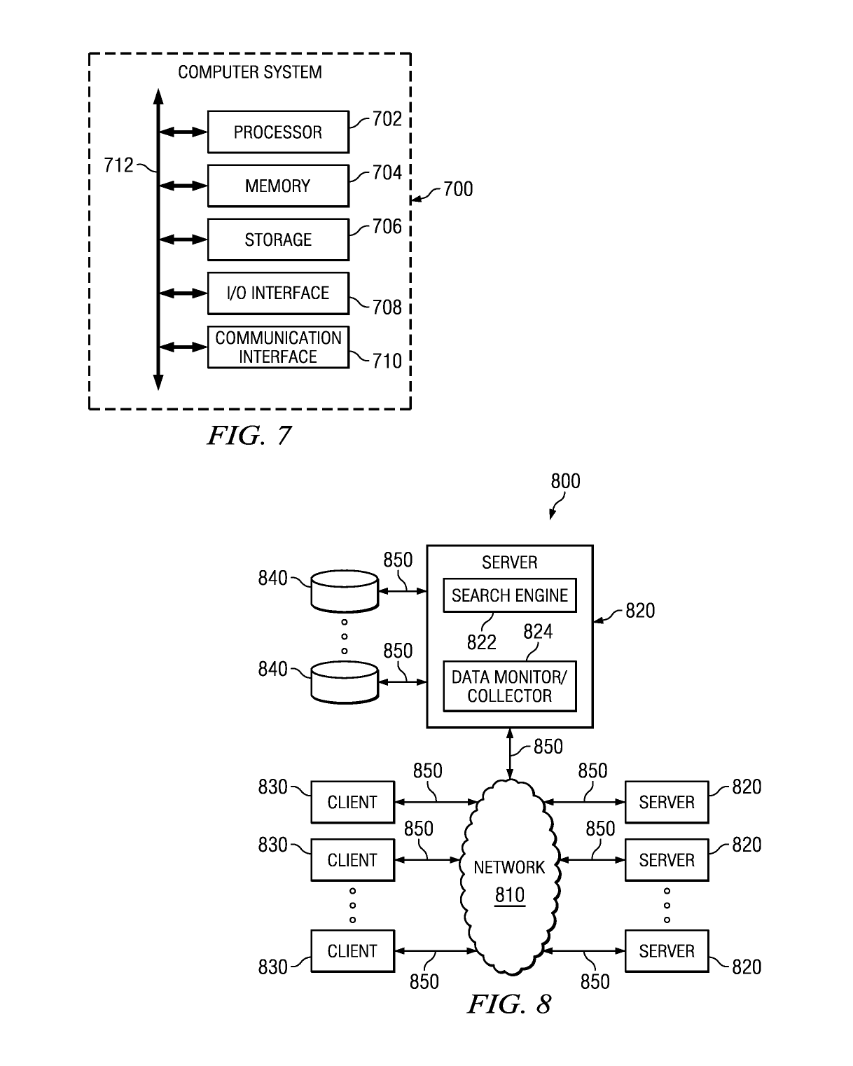

FIG. 8 illustrates an example network environment 800. This disclosure contemplates any suitable network environment 800. As an example and not by way of limitation, although this disclosure describes and illustrates a network environment 800 that implements a client-server model, this disclosure contemplates one or more portions of a network environment 800 being peer-to-peer, where appropriate. Particular embodiments may operate in whole or in part in one or more network environments 800. In particular embodiments, one or more elements of network environment 800 provide functionality described or illustrated herein. Particular embodiments include one or more portions of network environment 800. Network environment 800 includes a network 810 coupling one or more servers 820 and one or more clients 830 to each other. This disclosure contemplates any suitable network 810. As an example and not by way of limitation, one or more portions of network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 couple servers 820 and clients 830 to network 810 or to each other. This disclosure contemplates any suitable links 850. As an example and not by way of limitation, one or more links 850 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 850. In particular embodiments, one or more links 850 each includes an intranet, an extranet, a VPN, a LAN, a WLAN, a WAN, a MAN, a communications network, a satellite network, a portion of the Internet, or another link 850 or a combination of two or more such links 850. Links 850 need not necessarily be the same throughout network environment 800. One or more first links 850 may differ in one or more respects from one or more second links 850.

This disclosure contemplates any suitable servers 820. As an example and not by way of limitation, one or more servers 820 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 820 includes hardware, software, or both for providing the functionality of server 820. As an example and not by way of limitation, a server 820 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 830, the web server may communicate one or more such files to client 830. As another example, a server 820 that operates as a mail server may be capable of providing e-mail services to one or more clients 830. As another example, a server 820 that operates as a database server may be capable of providing an interface for interacting with one or more data stores (such as, for example, data stores 840 described below). Where appropriate, a server 820 may include one or more servers 820; be unitary or distributed; span multiple locations; span multiple machines; span multiple datacenters; or reside in a cloud, which may include one or more cloud components in one or more networks.

In particular embodiments, one or more links 850 may couple a server 820 to one or more data stores 840. A data store 840 may store any suitable information, and the contents of a data store 840 may be organized in any suitable manner. As an example and not by way or limitation, the contents of a data store 840 may be stored as a dimensional, flat, hierarchical, network, object-oriented, relational, XML, or other suitable database or a combination or two or more of these. A data store 840 (or a server 820 coupled to it) may include a database-management system or other hardware or software for managing the contents of data store 840. The database-management system may perform read and write operations, delete or erase data, perform data deduplication, query or search the contents of data store 840, or provide other access to data store 840.

In particular embodiments, one or more servers 820 may each include one or more search engines 822. A search engine 822 may include hardware, software, or both for providing the functionality of search engine 822. As an example and not by way of limitation, a search engine 822 may implement one or more search algorithms to identify network resources in response to search queries received at search engine 822, one or more ranking algorithms to rank identified network resources, or one or more summarization algorithms to summarize identified network resources. In particular embodiments, a ranking algorithm implemented by a search engine 822 may use a machine-learned ranking formula, which the ranking algorithm may obtain automatically from a set of training data constructed from pairs of search queries and selected Uniform Resource Locators (URLs), where appropriate.

In particular embodiments, one or more servers 820 may each include one or more data monitors/collectors 824. A data monitor/collection 824 may include hardware, software, or both for providing the functionality of data collector/collector 824. As an example and not by way of limitation, a data monitor/collector 824 at a server 820 may monitor and collect network-traffic data at server 820 and store the network-traffic data in one or more data stores 840. In particular embodiments, server 820 or another device may extract pairs of search queries and selected URLs from the network-traffic data, where appropriate.

This disclosure contemplates any suitable clients 830. A client 830 may enable a user at client 830 to access or otherwise communicate with network 810, servers 820, or other clients 830. As an example and not by way of limitation, a client 830 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 830 may be an electronic device including hardware, software, or both for providing the functionality of client 830. As an example and not by way of limitation, a client 830 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 830 may include one or more clients 830; be unitary or distributed; span multiple locations; span multiple machines; span multiple datacenters; or reside in a cloud, which may include one or more cloud components in one or more networks.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
accessing, using one or more processors associated with one or more computing devices, a first event profile for a first event, the first event profile comprising at least one seed parameter and one or more first parameters, wherein each seed parameter has been identified as being associated with fraud, and wherein each first parameter is related to a seed parameter by one degree of separation;
calculating, using the one or more processors, a fraud score for each of the first parameters based on one or more attributes of the first parameter and the relation of the first parameter to one or more of the seed parameters;
accessing, using the one or more processors, one or more second event profiles for one or more second events, respectively, each second profile comprising one or more second parameters, wherein one or more of the second parameters for each second event profile corresponds to one or more of the first parameters, and wherein each second parameter is related to a seed parameter by no more than two degrees of separation;
calculating, using the one or more processors, a fraud score for each of the second parameters based on (1) one or more attributes of the second parameter, (2) the relation of the second parameter to the first parameters, and (3) the fraud scores of the first parameters; and
identifying, using the one or more processors, at least one second parameter as being associated with fraud based on the fraud scores for the second parameters.

2. The method of claim 1, further comprising:
creating, using the one or more processors, a graph structure comprising a plurality of nodes and edges between the nodes, the graph structure comprising:
one or more seed nodes, each seed node representing a seed parameter;
one or more first node, each first node representing a first parameter, each first node being related to the seed node by one degree of separation; and
one or more second nodes, each second node representing a second parameter, each second node being related to the seed node by no more than two degrees of separation;
for each first parameter, assigning, using the one or more processors, the fraud score for the first parameter to the first node representing the first parameter;
for each of the second parameters, assigning, using the one or more processors, the fraud score for the second parameter to the second node representing the second parameter; and
for each second parameter identified as being associated with fraud, identifying, using the one or more processors, the second node representing the second parameter as being associated with fraud.

3. The method of claim 1, wherein identifying one or more of the second parameters as being associated with fraud based on the fraud score of each of the second parameters comprises, for each second parameter:
determining, using the one or more processors, whether the fraud score for the second parameter is greater than a threshold fraud score.

4. The method of claim 1, further comprising:
for each second event profile comprising one or more second parameters that have been identified as associated with fraud, denying, using the one or more processors, requests to pay out funds associated with the second event profile.

5. The method of claim 1, further comprising:
transmitting, using the one or more processors, the fraud score for one or more of the second parameters for presentation to a user.

6. The method of claim 1, further comprising:
determining, using the one or more processors, a rank for each parameter, wherein the fraud score for each parameter is a percentile rank equal to the percentage of other parameters that have a fraud score the same or lower than the parameter.

7. The method of claim 1, wherein a parameter comprises: an event identifier (ID); an email address of a user; an IP address of a user; a user ID of a user; a credit card number of a user; a device ID of a user; or any combination thereof.

8. The method of claim 7, wherein the user is an organizer of an event.

9. The method of claim 7, wherein the user is an attendee of an event.

10. The method of claim 1, wherein the attribute of a parameter comprises: a type of the parameter; a value of the parameter; a multiplicity of the value of the parameter; a degree of separation of the parameter from one of the seed parameters; or any combination thereof.

11. An apparatus comprising: one or more processors; and a memory coupled to the processors comprising instructions executable by the processors, the processors operable when executing the instructions to:
access a first event profile for a first event, the first event profile comprising at least one seed parameter and one or more first parameters, wherein each seed parameter has been identified as being associated with fraud, and wherein each first parameter is related to a seed parameter by one degree of separation;
calculate a fraud score for each of the first parameters based on one or more attributes of the first parameter and the relation of the first parameter to one or more of the seed parameters;
access one or more second event profiles for one or more second events, respectively, each second profile comprising one or more second parameters, wherein one or more of the second parameters for each second event profile corresponds to one or more of the first parameters, and wherein each second parameter is related to a seed parameter by no more than two degrees of separation;
calculate a fraud score for each of the second parameters based on (1) one or more attributes of the second parameter, (2) the relation of the second parameter to the first parameters, and (3) the fraud scores of the first parameters; and
identify at least one second parameter as being associated with fraud based on the fraud scores for the second parameters.

12. The apparatus of claim 11, wherein the processors are further operable when executing the instructions to:
create a graph structure comprising a plurality of nodes and edges between the nodes, the graph structure comprising:
one or more seed nodes, each seed node representing a seed parameter;
one or more first node, each first node representing a first parameter, each first node being related to the seed node by one degree of separation; and
one or more second nodes, each second node representing a second parameter, each second node being related to the seed node by no more than two degrees of separation;
for each first parameter, assign the fraud score for the first parameter to the first node representing the first parameter;
for each of the second parameters, assign the fraud score for the second parameter to the second node representing the second parameter; and
for each second parameter identified as being associated with fraud, identify the second node representing the second parameter as being associated with fraud.

13. The apparatus of claim 11, wherein to identify one or more of the second parameters as being associated with fraud based on the fraud score of each of the second parameters comprises, for each second parameter:
determine whether the fraud score for the second parameter is greater than a threshold fraud score

14. The apparatus of claim 11, wherein the processors are further operable when executing the instructions to:
for each second event profile comprising one or more second parameters that have been identified as associated with fraud, deny requests to pay out funds associated with the second event profile.

15. The apparatus of claim 11, wherein the processors are further operable when executing the instructions to:
transmit the fraud score for one or more of the second parameters for presentation to a user.

16. The apparatus of claim 11, wherein the processors are further operable when executing the instructions to:
determine a rank for each parameter, wherein the fraud score for each parameter is a percentile rank equal to the percentage of other parameters that have a fraud score the same or lower than the parameter.

17. The apparatus of claim 11, wherein a parameter comprises: an event identifier (ID); an email address of a user; an IP address of a user; a user ID of a user; a credit card number of a user; a device ID of a user; or any combination thereof.

18. The apparatus of claim 17, wherein the user is an organizer of an event.

19. The apparatus of claim 17, wherein the user is an attendee of an event.

20. The apparatus of claim 11, wherein the attribute of a parameter comprises: a type of the parameter; a value of the parameter; a multiplicity of the value of the parameter; a degree of separation of the parameter from one of the seed parameters; or any combination thereof.
